(19) United States
(12) Patent Application Publication
(10) Pub. No.: US 2012/0284073 A1
(43) Pub. Date: Nov. 8, 2012

(54) OPTIMIZED COLLABORATION BETWEEN DISTRIBUTED CENTERS OF GLOBAL SERVICE DELIVERY SYSTEMS

(75) Inventors: SHIVALI AGARWAL, GHAZIABAD (IN); SAEED BAGHERI, CROTON ON HUDSON, NY (US); JARIR K. CHAAR, ARDSLEY, NY (US); KRISHNA C. RATAKONDA, YORKTOWN HEIGHTS, NY (US); BIKRAM SENGUPTA, BANGALORE (IN)

(73) Assignee: INTERNATIONAL BUSINESS MACHINES CORPORATION, ARMONK, NY (US)

(21) Appl. No.: 13/099,504

(22) Filed: May 3, 2011

(51) Int. Cl. G06Q 10/00

(52) U.S. Cl. 705/7.13

(57) ABSTRACT

A computer implemented method, system, and/or computer program product facilitate optimal collaboration between cells from different service centers for delivering a service to a customer. A cost of collaboration between two cells in different service centers is defined. Each of the two cells is a group of resources capable of executing a same task, and the cost is a 3-Tuple that consists of a monetary cost, a makespan cost, and a skill misalignment cost associated with the collaboration. After establishing acceptable cost ranges for the 3-Tuple based on constraints defined by an enterprise policy, a processor creates multiple collaboration matrices based on different permutations of the 3-Tuple. Once an optimal collaboration function derived from the multiple collaboration matrices is identified, the task is assigned to two optimal cells identified in the optimal collaboration function.

### BACKGROUND

The present disclosure relates to the field of computers, and specifically to the use of computers in the field of using resources from different systems. Still more particularly, the present disclosure relates to sharing resources between different systems.

A global service delivery system can have service centers at geographically distributed locations. Some considerations in deciding the location for creating a center are proximity of the customers, the favorable economic conditions of a location and so on. There is an assumption that the various service centers are homogeneous in nature, in the sense that their organization and the processes followed for service delivery are uniform and follow the shared delivery model; that is, the resource information across centers is available to each center. Once such centers are operational, they can either work in isolation, in which they are responsible for their own projects, or a collaborative environment. The use of collaborative environments offers the advantage of encouraging the leverage of human resources and expertise across the different centers.

### BRIEF SUMMARY

A computer implemented method, system, and/or computer program product facilitate optimal collaboration between cells from different service centers for delivering a service to a customer. A cost of collaboration between two cells in different service centers is defined. Each of the two cells is a group of resources capable of executing a same task, and the cost is a 3-Tuple that consists of a monetary cost, a makespan cost, and a skill misalignment cost associated with the collaboration. After establishing acceptable cost ranges for the 3-Tuple based on constraints defined by an enterprise policy, a processor creates multiple collaboration matrices based on different permutations of the 3-Tuple. Once an optimal collaboration function derived from the multiple collaboration matrices is identified, the task is assigned to two optimal cells identified by the optimal collaboration function.

### BRIEF DESCRIPTION OF THE SEVERAL VIEWS OF THE DRAWINGS

FIG. 1 depicts an exemplary computer in which the present disclosure may be implemented; and

FIG. 2 is a high level flow chart of one or more exemplary steps performed by a processor to manage collaboration between cells in service centers.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

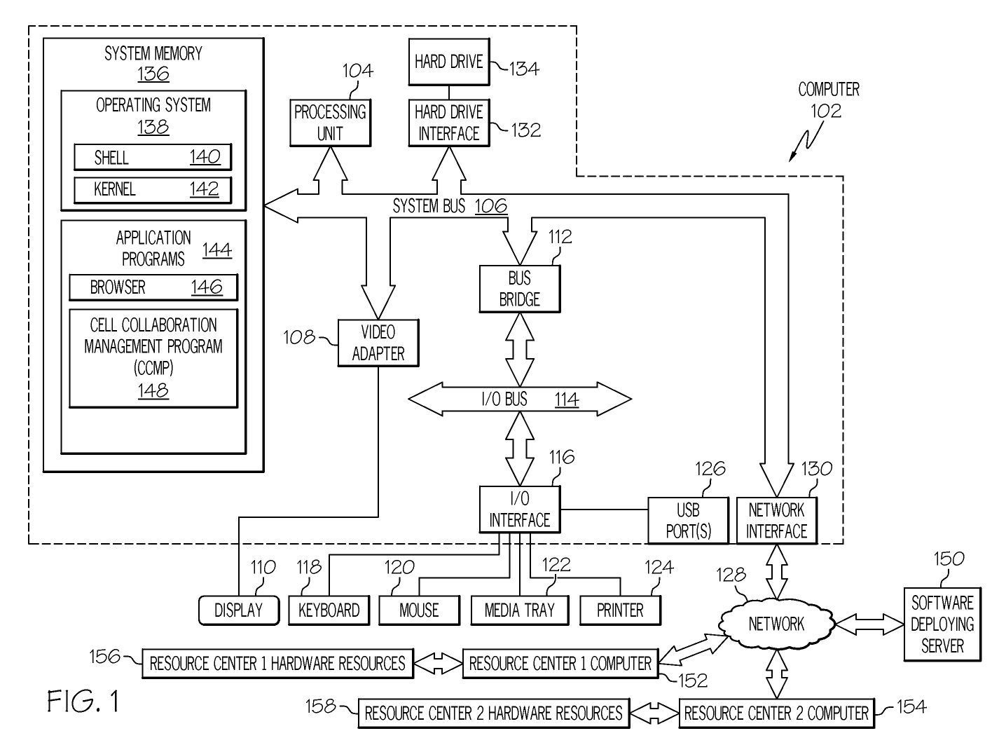

With reference now to the figures, and in particular to FIG. 1, there is depicted a block diagram of an exemplary computer 102, which may be utilized by the present invention. Note that some or all of the exemplary architecture, including both depicted hardware and software, shown for and within computer 102 may be utilized by software deploying server 150, a resource center 1 computer 152, and a resource center 2 computer 154.

Computer 102 includes a processing unit 104 that is coupled to a system bus 106. Processing unit 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/0 bus 114. I/O interface 116 affords communication with various I/O devices, including a keyboard 118, a mouse 120, a media tray 122 (which may include storage devices such as CD-ROM drives, multi-media interfaces, etc.), a printer 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other computer systems.

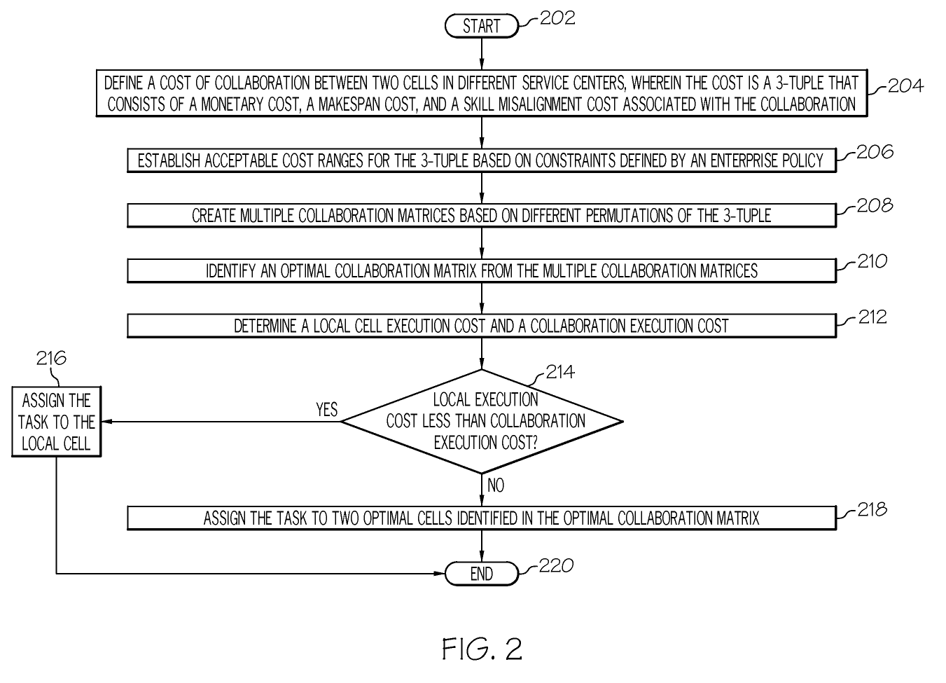

Application programs 144 in computer 102's system memory (as well as software deploying server 150's system memory) also include a cell collaboration management program (CCMP) 148. CCMP 148 includes code for implementing the processes described below, including those described in FIG. 2. In one embodiment, computer 102 is able to download CCMP 148 from software deploying server 150, including in an on-demand basis, wherein the code in CCMP 148 is not downloaded until needed for execution to define and/or implement the improved enterprise architecture described herein. Note further that, in one embodiment of the present invention, software deploying server 150 performs all of the functions associated with the present invention (including execution of CCMP 148), thus freeing computer 102 from having to use its own internal computing resources to execute CCMP 148.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

The present disclosure focuses on the collaborative form of working More specifically, the present disclosure presents a system that aids in deciding the optimal way of collaborating between centers for a work stream. A starting point in the presently presented process is to define specific decision making factors used to choose centers for a work packet's execution. Thereafter, an optimization framework for arriving at work assignment to the centers is built by casting these factors as cost functions. In one embodiment, an organizational policy governs how to assign weights to these cost functions when doing the actual scheduling.

The structure of delivery centers and the work streams which are the subject of scheduling is now described. A work stream can be conceptualized as a composite representation of tasks (related tasks which together make up a project) and resources. Higher level units (e.g., collections) of resources are used in an effective and efficient manner to carry out the unit formed out of related tasks. The challenge lies in deciding if and how the different resource units should be used for completing related tasks, given the fact that collaboration has pros and cons. On one hand, collaboration allows access to extra resources, which is cost effective. On the other hand, collaboration can cause delays, due to ineffective communication between the geographically separated resource units, language barriers, time zone differences, different holiday schedules, coordination overhead, etc.

Exemplary delivery centers have the following structure of activities, resources and defined notions of collaboration:

### 1. Project Activities are Composite in Nature.

That is, an activity is a work packet that has constituent tasks of a skill type and level and precedence relation that exists between the tasks. Work packets may also have some precedence relation between them. Each work packet has the information of the customer location. A work stream is a collection of work packets.

### 2. Estimates for a Task are Provided for a Particular Skill Level.

Each task requires a certain level of expertise. These levels can be scaled, in order to the estimate if the use of other skill levels is possible. If the use of other skill levels is possible/feasible/practical, then a task that is designed to be executed by one having a certain skill level may be executed by one having a lower/higher skill level. For example, if a worker has a skill level of 5 (maximum), and the estimate of time for that worker to complete the task is T units of time, then the estimate of time for a worker having a skill level of 3 may be 2 T units of time. Similarly, if a job is designed to be executed by a worker having a skill level of 3 in order to accomplish the task at T units of time, then a worker having a skill level of 4 may be able to complete the task in 0.75 T units of time. In the model/decision making processes described herein, these scaling factors are used as inputs.

3. A Resource may have Multiple Skills with a Defined Skill Level for Each of His Skills.

In the present disclosure, resources are grouped into cells. Each cell may have workers with different skills and skill levels, as well as hardware/computer resources that have different capabilities/availability/software/etc. Cells may be in different geographic locations and one delivery center can have more than one cell.

4. A Cell Is Primarily Responsible for a Work Packet, but it can use Resources from Other Cells for Some Of The Tasks In This Work Packet.

This scenario is called collaboration. A collaboration can result in faster work completion. However, for reasons discussed above, makespan (the time taken to complete a task/project/) delays can also be incurred due to communication delays caused by different time zones etc.

5. There is a Collaboration Matrix which Maintains the Cost of Collaboration Between Each Pair of Cells.

The cost of collaboration is in terms of the extra time that will be taken when the two cells collaborate. In one embodiment, this cost is calculated/derived by tracking delays (obtained from historical data in which two cells have collaborated in the past) caused by the management overhead of collaboration, including the time spent in clarification of issues due to different time zones. In one embodiment, the historical data is from two particular cells using the same resources (human and/or hardware/software) for a same or similar job/task/project as currently being contemplated for collaboration. In another embodiment, the historical data is from two particular cells that collaborated on any type of job/task/project using the same resources as are currently available.

In one embodiment, the collaboration matrix leads to the derivation of a function (e.g., a computer-executed algorithm) that compares the cost of two cells collaborating based on monetary cost, makespan cost, and skill misalignment cost associated with past collaborations. The monetary cost is the cost in dollars (or some other currency) associated with the collaboration. This monetary cost may be due to the monetary cost charged against a first cell that will be using a second cell; lost revenues by the second cell if it is tied up collaborating with the first cell; management costs associated with coordinating the collaboration between the first and second cells; etc. The makespan cost describes how long it takes to complete a job/task/project when two cells collaborate on that job/task/project. The skill misalignment cost describes how much compromise must be made on skill level preferences. That is, if a particular job/task/project has a service level agreement (SLA) that requires the work to be performed by a worker/resource having a specified level of competence/expertise, then using lesser qualified workers/resources may result in an SLA penalty, delay in job completion, etc.

The collaboration matrix, based on various permutations of historical data/costs, is thus used to capture the cost effectiveness of using a resource from the cells in other geographic locations. Note that in one embodiment the collaboration matrix is defined for all possible, or at least feasible, cell pairs up to some predefined limit of combinations.

### 6. A Resource can Work on One Task at a Time.

Note that in one embodiment, the basic unit of assignment for a resource is a task, and not an entire work packet. Thus, the collaboration matrix described above has a task-level granularity. Any resource with the required skill can do the task provided the work-requirement estimates are appropriately scaled according to the required level of that skill for that task. That is, each skill level can be weighted in order to normalize the different permutations of 3-Tuple costs, including the skill misalignment costs.

7. Cost of a Resource is According to the Skill and the Level which is Pre-Specified for One Geographic Location.

The cost of resources can be computed by the relative cost component of collaboration matrix. That is, a particular resource may cost 10.0 cost units in one location, while that same resource may only cost only 5.0 cost units in another location. These cost units may be any of the costs in a 3-Tuple that consists of a monetary cost, a makespan cost, and a skill misalignment cost associated with the collaboration. In one embodiment, this t-Tuple consists of only the monetary cost, makespan cost, and skill misalignment cost associated with the collaboration.

Given the above structure and definitions, a generalized model for collaboration is generated in the form of a multi-objective optimization problem. This problem is solved in order to answer scheduling questions such as:
Which cells should collaborate for a work packet such that the desired objective of minimum cost in given time frame can be achieved?
Given the collaboration overheads, can a high skilled person from another cell be utilized in case of non availability of one in the responsible cell to carry out the tasks?
Can cost be reduced by utilizing resources across cells and still maintain the deadline?
Is it possible to carry out the schedule with complete skill match between tasks and resources within a cell/ across cells?

Each of these questions is driven by the policy based scheduling. For example, an organization can have a policy like “ignore skill mismatch as long as costs are minimized” or “limit the usage of low skilled person from other cells to some number n”, etc. Thus, the enterprise policy defines constraints, which can be used by the 3-Tuple for establishing acceptable cost ranges.

### Optimization Model

The decision factors responsible for the level of collaboration in the work stream assignment are:
Reduced cost in terms of money (monetary cost);
Reduced makespan of the work packets (makespan cost); and
Reduced skill mismatches (skill misalignment cost).

There is an inherent tradeoff between these factors. That is, just reducing monetary cost may result in a pronounced skill mismatch cost, while a complete skill match may result in increased time span for completing the task/job/project (makespan cost), depending on resource availability spread across geographies. If an attempt is made to reduce makespan costs, then more monetary costs may be incurred due to task assignment to higher skilled people. Thus, the collaborative scheduling or the assignment problem in such systems becomes a 3-dimensional (i.e., 3-Tuple) problem with monetary cost, makespan cost and skill misalignment cost being the 3 dimensions. Each dimension either supports or conflicts the other.

The problem of collaborative working that is optimized with respective to either all or some of these cost factors is solved by posing it as a multi-objective optimization problem such that:
The decision factors are modeled as objective functions of the optimization problem. Thus, the decision factors are basically the cost functions; and
The constraints are derived from the structure of the delivery systems that has been given above.

A model of the optimized use of resources during collaboration between cells is now described.

### Constraints

Exemplary constraints to the optimization model are given below. Constraints that model precedence; non-preemption; resource availability; and bijective mapping between a task and a resource at any instant in time are assumed to be present.

Each of the work packets is associated with a cell. This cell becomes the base cell to compute the collaboration cost for the tasks, in order to generate the optimization model. In one embodiment, the base cell is the one that is physically closest to the customer location.

Time taken for a resource with skill level 1′ to complete a task that requires skill level 1 is equal to the sum of i) estimate scaled by the factor 1′/1 as provided in the system and ii) the time component the collaboration matrix entry of the cell pair.

The precedence constraints between tasks take into account the extra time due to collaboration in the form of delays.

The skill misalignment cost is determined by the skill that is wanted and the skill level possessed by a resource/person/hardware.

The total cost is thus the relative cost component of the cell pair entry (i.e., the cost of the collaboration of that cell pair) in the collaborative matrix.

In one embodiment, a class of constraints are of the form of an upper/lower bound on the number of collaborating cells; an upper/lower bound on the number of resources of particular skill type and level that can be used from certain cells; strict/relaxed adherence to due dates for work packet completion; etc. Such constraints are specific to requirements of delivery systems and therefore may be made optional in order to be able to model a generalized model.

### Objective Functions

In one embodiment, a family of objective functions is used to arrive at the desired schedule (found in the model of optimized use of resources during collaboration) that satisfies the constraints described above. These objective functions include:

Cost minimization: For each work packet, minimize the cost of resources by trying each valid resource-task pair combination across cells and compute costs with respect to the base cell; and

Makespan minimization: For each work packet, minimize the time taken to complete the tasks with respect to the base cell.

Skill level mismatch minimization: Minimize the mismatch in the skill levels when choosing a resource for a task. Note that skill level match may be an important requirement from the point of view of worker satisfaction.

It can be observed that the optimization problem implicitly treats the resources in all the cells as one big shared resource pool, but where each resource has a specialized property based on the cell to which it belongs, with respect to the base cell, governed by the collaboration matrix. Some examples of possible combinations of the objective functions are: collaborate in order to minimize skill mismatch as the primary objective rather than cost and time; and bound the number of skill mismatches and then optimize on time and cost. It is also possible in the above model to specify the subset of cells among which the collaboration is warranted. The work assignment is then computed based on the desired objectives. In this case, the solution may consist of only some of the members of the specified subset as the collaborating cells.

With reference now to FIG. 2, a high level flow chart of one or more exemplary steps performed by a processor to facilitating optimal collaboration between cells from different service centers for delivering a service to a customer is presented. After initiator block 202, a cost of collaboration between two cells in different service centers is defined (block 204). In one embodiment, each of the two cells is a group of resources, human and/or hardware/software, capable of executing a same task. The cost of collaboration is a 3-Tuple that includes a monetary cost, a makespan cost, and a skill misalignment cost associated with said collaboration. As described herein, the monetary cost is the cost in money associated with the collaboration (i.e., monetary costs associated with leasing/sharing resources, collaboration oversight/management, etc.). The makespan cost is the length of time required to perform a job/task/project using cell collaboration. The skill misalignment cost is the level of misalignment between which skill capacity is specified for a job/task/project versus what is actually used during the cell collaboration. Note that in one embodiment, these costs are normalized. For example, assume that the monetary cost has a value of 10 C, the makespan cost has a value of 5 M, and the skill misalignment cost has a value of 2 S. Without any cost weighting, the normalized value is simply the sum (10+5+2=17) of the costs, even though they use different units. Thus, another pair of cells having a monetary cost of 5 C, a makespan cost of 8 M, and a skill misalignment cost of 4 S, resulting in a same normalized cost value of 17 (5+8+4). Absent any policy overrides or weightings of the individual costs (e.g., weighing the monetary cost to be twice that of the skill misalignment cost), then this second pairing of cells will be treated as having the same weighted cost as the first pairing of cells.

As described in block 206, acceptable cost ranges for the 3-Tuple is established based on constraints defined by an enterprise policy. For example, if an enterprise policy states that the monetary cost cannot exceed a certain dollar amount, then the acceptable cost range for the monetary cost must below that figure. Similarly, if an enterprise policy states that the makespan cost cannot exceed a certain amount of time (i.e., to complete the job/task/project), then that constraint must also be respected. Similarly, if an enterprise policy states skill misalignment cost must not be so high as to allow unqualified resources (e.g., workers without required training/experience; computers without certain software loaded thereon, etc.) to work on the job/task/project.

As described in block 208, multiple collaboration matrices are created based on different permutations of the 3-Tuple. That is, using various ranges of costs for sharing cells results in different total costs represented in the 3-Tuple. Each of these multiple collaboration matrices contains 3-Tuple cost values. For example, in one embodiment each cell shows the cost of collaborating with a same other cell, but each cell uses a different cost value for one or more of the 3-Tuple costs. In another embodiment, the same cost value for one or more of the 3-Tuple costs remains the same, but different cells are associated with a local cell in each permutation. An optimal collaboration function is derived from one of these multiple collaboration matrices. That is, based on the contents of the cells in the matrices, an optimal collaboration function, which is computer-executable, is derived from one of the collaboration matrices.

Thus, as described in block 210, an optimal collaboration function is derived from the multiple collaboration matrices. This optimal collaboration function expends a lower overall monetary cost, makespan cost, and skill misalignment cost as compared to other collaboration functions from the multiple collaboration matrices.

Referring now to block 212, assume that the two cells described herein are a local cell and a remote cell. These two cells may be physically separated, or they may be local/remote based on being owned/managed by different enterprises, may be local/remote based on different types of resources (e.g., different operating system platforms, different software, different education levels of workers, etc.) used by the two cells. In this scenario, a local cell execution cost is determined. That is, the cost of executing the job/task/project without collaborating with another cell is calculated based on the 3-Tuple associated with executing the task solely within the local cell. If it is cheaper for the local cell to process the job/task/project without collaborating with another cell (query block 214), then that task is simply assigned to the local cell for execution (block 216). However, if the cost of executing the task is cheaper if done by collaborating with another cell (query block 214), then the task is assigned to the two cells to execute in collaboration (block 218). The process ends at terminator block 220.

Note that, as described herein, the shared/collaborative resources may be hardware resources, such as resource center 1 hardware resources 156 and resource center 2 hardware resources 158. These respective resources can be considered to be the two cells described above. In order to determine what hardware resources are actually available within resource center 1 hardware resources 156 and resource center 2 hardware resources 158, signals are sent from respective resource center 1 computer 152 and resource center 2 computer 154, which are management computers that “know” the features, availability, cost, etc. of resource center 1 hardware resources 156 and resource center 2 hardware resources 158. When computer 102 receives these signals, it is then able to derive the 3-Tuple described herein and associated with resource center 1 hardware resources 156 and resource center 2 hardware resources 158 sharing their resources to accomplish/execute a certain job/task/project.

Thus, described herein is a system that facilitates an optimal way of collaboration between cells for carrying out work in a project. A collaboration matrix defines the cost of collaboration between two cells in terms of time and money. A model of the constraints on work packets and resources is built based on decision making factors that govern the collaboration decision. These factors capture the tradeoffs involved in the decision making process. The model also incorporates the use of a family of objective functions that model the 3 dimensions of the problem of deciding the collaboration level, namely: cost, makespan, skill match. This allows for modeling the underlying tradeoffs in the desired manner. Ultimately, a solution to the optimization problem manifests in the form of work assignment to various cells. The solution can also manifest as task assignment to resources. The cost of collaboration is thus deduced from the solution.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the invention of the present application in detail and by reference to illustrative embodiments thereof, it will be apparent that modifications and variations are possible without departing from the scope of the invention defined in the appended claims.

What is claimed is:

1. A computer implemented method of facilitating optimal collaboration between cells from different service centers for delivering a service to a customer, the computer implemented method comprising:
a processor defining a cost of collaboration between two cells in different service centers, wherein each of the two cells is a group of resources capable of executing a same task, and wherein the cost is a 3-Tuple that consists of a monetary cost, a makespan cost, and a skill misalignment cost associated with said collaboration;
the processor establishing acceptable cost ranges for the 3-Tuple based on constraints defined by an enterprise policy;
the processor creating multiple collaboration matrices based on different permutations of the 3-Tuple;
the processor identifying an optimal collaboration function derived from one of the multiple collaboration matrices, wherein the optimal collaboration function expends a lower overall monetary cost, makespan cost, and skill misalignment cost as compared to other collaboration functions derived from the multiple collaboration matrices; and
the processor assigning the task to two optimal cells identified in the optimal collaboration function.

2. The computer implemented method of claim 1, wherein the two cells are a local cell and a remote cell, and wherein the computer implemented method further comprises:
the processor determining a local cell execution cost that comprises the 3-Tuple associated with executing the task solely within the local cell without collaborating with the foreign cell;
the processor determining a collaboration execution cost based on executing the task in the two optimal cells identified by the optimal collaboration function
the processor, in response to determining that the local cell execution cost is less than the collaboration execution cost, assigning the task to the local cell.

3. The computer implemented method of claim 2, further comprising:
the processor normalizing the different permutations of the 3-Tuple by assigning predetermined weighting factors to each of the monetary cost, makespan cost, and skill misalignment cost in the 3-Tuple.

4. The computer implemented method of claim 1, wherein the group of resources comprises hardware resources, and wherein the computer implemented method further comprises:
the processor receiving a first signal from a first group of hardware resources and a second signal from a second group of hardware resources, wherein the first signal and the second signal respectively describe the first group of hardware resources and the second group of hardware resources; and
the processor deriving the 3-Tuple from the first and second signals.

5. A computer program product for facilitating optimal collaboration between cells from different service centers for delivering a service to a customer, the computer program product comprising:
a computer readable storage media;
first program instructions to define a cost of collaboration between two cells in different service centers, wherein each of the two cells is a group of resources capable of executing a same task, and wherein the cost is a 3-Tuple that consists of only a monetary cost, a makespan cost, and a skill misalignment cost associated with said collaboration;
second program instructions to establish acceptable cost ranges for the 3-Tuple based on constraints defined by an enterprise policy;
third program instructions to create multiple collaboration matrices based on different permutations of the 3-Tuple;
fourth program instructions to identify an optimal collaboration function derived from one of the multiple collaboration matrices, wherein the optimal collaboration function expends a lower overall monetary cost, makespan cost, and skill misalignment cost as compared to other collaboration functions derived from the multiple collaboration matrices; and
fifth program instructions to assign the task to two optimal cells identified by the optimal collaboration function; and wherein
the first, second, third, fourth, and fifth program instructions are stored on the computer readable storage media.

6. The computer program product of claim 5, wherein the two cells are a local cell and a remote cell, and wherein the computer program product further comprises:
sixth program instructions to determine a local cell execution cost that comprises the 3-Tuple associated with executing the task solely within the local cell without collaborating with the foreign cell;
seventh program instructions to determine a collaboration execution cost based on executing the task in the two optimal cells identified in the optimal collaboration function; and
eighth program instructions to, in response to determining that the local cell execution cost is less than the collaboration execution cost, assign the task to the local cell; and wherein the sixth, seventh, and eighth program instructions are stored on the computer readable storage media.

7. The computer program product of claim 6, further comprising:
ninth program instructions to normalizing the different permutations of the 3-Tuple by assigning predetermined weighting factors to each of the monetary cost, makespan cost, and skill misalignment cost in the 3-Tuple; and wherein the ninth program instructions are stored on the computer readable storage media.

8. The computer program product of claim 4, wherein the group of resources comprises hardware resources, and wherein the computer program product further comprises:
sixth program instructions to receive a first signal from a first group of hardware resources and a second signal from a second group of hardware resources, wherein the first signal and the second signal respectively describe the first group of hardware resources and the second group of hardware resources; and
seventh program instructions to derive the 3-Tuple from the first and second signals; and wherein
the sixth and seventh program instructions are stored on the computer readable storage media.

9. A computer system comprising:
a central processing unit (CPU), a computer readable memory, and a computer readable storage media;
first program instructions to define a cost of collaboration between two cells in different service centers, wherein each of the two cells is a group of resources capable of executing a same task, and wherein the cost is a 3-Tuple that consists of a monetary cost, a makespan cost, and a skill misalignment cost associated with said collaboration;
second program instructions to establish acceptable cost ranges for the 3-Tuple based on constraints defined by an enterprise policy;
third program instructions to create multiple collaboration matrices based on different permutations of the 3-Tuple;
fourth program instructions to identify an optimal collaboration function derived from one of the multiple collaboration matrices, wherein the optimal collaboration function expends a lower overall monetary cost, makespan cost, and skill misalignment cost as compared to other collaboration functions derived from the multiple collaboration matrices; and
fifth program instructions to assign the task to two optimal cells identified by the optimal collaboration function; and wherein
the first, second, third, fourth, and fifth program instructions are stored on the computer readable storage media for execution by the CPU via the computer readable memory.

10. The computer system of claim 9, wherein the two cells are a local cell and a remote cell, and wherein the system further comprises:
sixth program instructions to determine a local cell execution cost that comprises the 3-Tuple associated with executing the task solely within the local cell without collaborating with the foreign cell;
seventh program instructions to determine a collaboration execution cost based on executing the task in the two optimal cells identified in the optimal collaboration function; and
eighth program instructions to, in response to determining that the local cell execution cost is less than the collaboration execution cost, assign the task to the local cell; and wherein the sixth, seventh, and eighth program instructions are stored on the computer readable storage media for execution by the CPU via the computer readable memory.

11. The computer system of claim 10, further comprising:
ninth program instructions to normalizing the different permutations of the 3-Tuple by assigning predetermined weighting factors to each of the monetary cost, makespan cost, and skill misalignment cost in the 3-Tuple; and wherein
the ninth program instructions are stored on the computer readable storage media for execution by the CPU via the computer readable memory.

12. The computer system of claim 8, wherein the group of resources comprises hardware resources, and wherein the system further comprises:
sixth program instructions to receive a first signal from a first group of hardware resources and a second signal from a second group of hardware resources, wherein the first signal and the second signal respectively describe the first group of hardware resources and the second group of hardware resources; and
seventh program instructions to derive the 3-Tuple from the first and second signals; and wherein
the sixth and seventh program instructions are stored on the computer readable storage media for execution by the CPU via the computer readable memory.
